(19) United States
(12) Patent Application Publication
(10) Pub. No.: US 2021/0374776 A1
(43) Pub. Date: Dec. 2, 2021

(54) METHODS, SYSTEMS, ARTICLES OF MANUFACTURE, AND APPARATUS TO ENHANCE MARKET RESEARCH DATA COLLECTION QUALITY

(71) Applicant: Nielsen Consumer LLC, New York, NY (US)

(72) Inventors: Kannan Balaji, Tampa, FL (US); Brahmanand Reddy Shivampet, Oak Park, CA (US); Sedwin Sunny Vadukut, Tampa, FL (US)

(21) Appl. No.: 17/328,000

(22) Filed: May 24, 2021

Related U.S. Application Data
(60) Provisional application No. 63/031,147, filed on May 28, 2020.

(51) Int. Cl. G06Q 30/02; G06F 16/28; G06F 16/215; G06N 20/00

(52) U.S. Cl. CPC G06Q 30/0202; G06F 16/285; G06N 20/00; G06Q 30/0201; G06F 16/215

(57) ABSTRACT

Methods, systems, articles of manufacture, and apparatus to enhance market research data collection quality are disclosed. An example apparatus includes at least one memory: instructions; and at least one processor to execute the instructions to: aggregate marketing and sales data into a pool of data packets associated with different stores, the data packets including collection information associated with sales of a particular product sold at the corresponding ones of the different stores; classify different ones of the data packets into either an accurate data packet set or an inaccurate data packet set; determine whether to request replacement collection information for a first data packet in the inaccurate data packet set; and in response to a determination to request replacement collection information, cause transmission of a request to a data collector to provide the replacement collection information.

RELATED APPLICATION(S)

This patent arises from a non-provisional patent application that claims the benefit of U.S. Provisional Patent Application No. 63/031,147, which was filed on May 28, 2020. U.S. Provisional Patent Application No. 63/031,147 is hereby incorporated herein by reference in its entirety. Priority to U.S. Provisional Patent Application No. 63/031,147 is hereby claimed.

### FIELD OF THE DISCLOSURE

This disclosure relates generally to the technical field of market research, and, more particularly, to methods, systems, articles of manufacture, and apparatus to enhance market research data collection quality.

### BACKGROUND

Manufacturers, suppliers, distributors, and/or other product providers are often interested in maintaining the availability of their products for purchase by consumers at retail establishments. Such product providers are often also interested in the presentation of their products in retail establishments as well as how well their products are selling. Accordingly, such product providers may implement, initiate, and/or participate in market research systems that enable the collection of data that is indicative of product availability, presentation, and/or sales. Collecting and processing data indicative of such information in an accurate and reliable manner, especially when the data is obtained from many retail establishments and/or many consumers (e.g., numbering in the thousands or more), are just some of the technological challenges that must be overcome in the field of market research.

### BRIEF DESCRIPTION OF THE DRAWINGS

FIG. 1 is a schematic illustration of an example environment in which teachings disclosed herein may be implemented.

FIG. 2 is a block diagram of an example implementation of the example data processing apparatus of FIG. 1.

FIGS. 3 and 4 are flowcharts representative of example machine readable instructions that may be executed to implement the example data processing apparatus of FIGS. 1 and/or 2.

FIG. 5 is a block diagram of an example processor platform structured to execute the example machine readable instructions of FIGS. 3 and/or 4 to implement the example data processing apparatus of FIGS. 1 and/or 2.

The figures are not to scale. In general, the same reference numbers will be used throughout the drawing(s) and accompanying written description to refer to the same or like parts. Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein “substantially real time” refers to occurrence in a near instantaneous manner recognizing there may be real world delays for computing time, transmission, etc. Thus, unless otherwise specified, “substantially real time” refers to real time +/−1 second.

### DETAILED DESCRIPTION

An autonomous system to evaluate and iteratively improve market research data collection accuracy based on the patterns of various data collection features (or attributes) like sale units (e.g., number of individual items sold as a single unit), units per sale (e.g., number of units purchased at a single time), sale volume (e.g., total number of units sold in a given period), price and so on, is disclosed herein. Collection information like sale units, sale volume, price, promotion information from different stores using data collection channels like Point of Sale (PoS) systems, auditor applications, store owner applications, third-party vendor applications and so on, should be evaluated for data accuracy and recollected if required. Autonomous digital agents in the proposed evaluation system would evaluate the accuracy of collected data arriving from various data collection channels using machine learning models. Further, example autonomous digital agents also use machine learning models to determine whether to obtain additional and/or replacement data when previously collected data is found to be inaccurate and/or otherwise unreliable, thereby enabling the iterative improvement of the data collection accuracy. In some examples, in addition to and/or in lieu of collecting additional and/or replacement data, data collection is made effective and accuracy is also improved by synthesizing data collection information from different time periods and/or from different sources to generate simulated data that is used to fill in gaps in the collected data and/or to resolve inaccuracies identified therein.

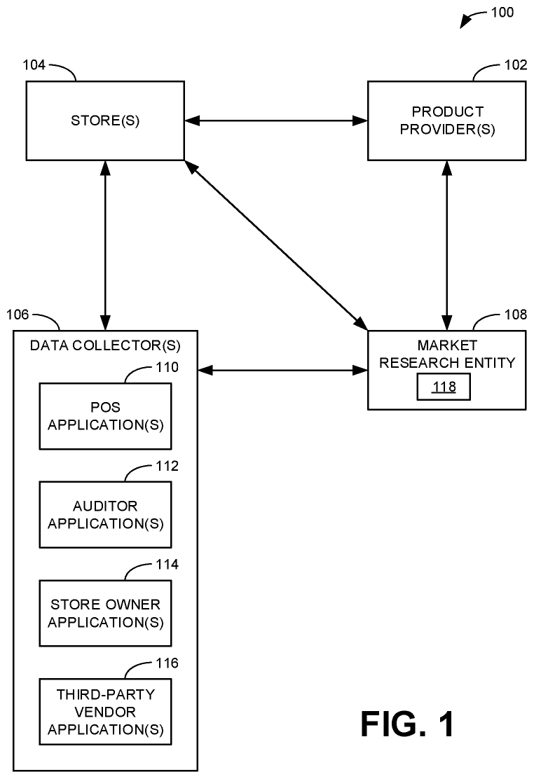

FIG. 1 is a schematic illustration of an example system 100 within which teachings disclosed herein may be implemented. The example system 100 of FIG. 1 includes one or more product provider(s) 102 that provide products to one or more store(s) 104 for sale. As used herein, a product provider is an entity that manufactures, produces, distributes, supplies, and/or otherwise provides products that may be purchased by consumers. As used herein, a store is an entity that is at the consumer-facing end of the product supply chain to interact directly with consumers purchasing products provided by the product providers 102. Although the product provider(s) 102 are shown as distinct entities in the illustrated example, in some instances, a product provider 102 may also be a store 104. In some examples, the store(s) 104 may be brick-and-mortar retail establishments that permit consumers into the premises to view and/or purchase goods. Additionally or alternatively, the store(s) 104 may sell their products via the Internet with their inventories stored at a location that is not open to physical access by consumers.

In the illustrated example of FIG. 1, one or more data collector(s) 106 may collect marketing and sales data for particular products offered for sale by the store(s) 104 and report their findings to a market research entity 108. The marketing and sales data may include information indicative of the inventory, stock status, price, sale units (e.g., number of individual items sold as a single unit), units per sale (e.g., number of units purchased at a single time), sale volume (e.g., total number of units sold in a given period), promotional details, product location within the store 104 (e.g., particular aisle, particular shelf, etc.), product presentation, and/or any other relevant information about the particular product(s) of interested at a particular point in time (when the data is collected) and/or for a given period of time (a most recent period preceding the collection of the data (e.g., the past week, the past month, etc.)). Data collected by the data collector(s) 106 corresponding to particular product(s) is referred to herein as collection information. The marketing and sales data may also include information indicative of the nature and/or characteristics of the store 104 from which collection information for particular product(s) is collected. Such data collected about the store(s) 104 is referred to herein as store information. Store information may include the store location (e.g., physical address and/or a broader geographic region (e.g., city, state, and/or country)), the store size (e.g., small, medium, or large), store type, (e.g., grocery store, pharmacy store, clothing store, sporting goods store, big-box store, etc.), and/or any other relevant information about the store 104.

In some examples, the store information may be collected and reported to the market research entity 108 by the data collector(s) 106. In some examples, the store information may be collected by the market research entity 108 independent of the data collector(s) 106. For instance, in some examples, the stores 104 may provide the store information directly to the market research entity 108 as part of an agreement to participate in market research studies conducted by the market research entity 108. More particularly, in some examples, the particular store(s) 104 for which marketing and sales data is collected are selected from a pool of stores 104 that have agreed to participate in research studies by the market research entity 108. Accordingly, in some examples, part of the process for a store 104 registering as a participant in the research studies may include providing the store information noted above.

In some examples, the marketing and sales data (e.g., collection information and/or store information) may be provided to the market research entity 108 via one or more different data collection channels associated with different types of data collector(s) 106. More particularly, as shown in the illustrated example, a particular data collector 106 may include and/or implement at least one of a Point-of-Sale (POS) application 110, an auditor application 112, a store owner application 114, and/or a third-party vendor application 116.

In some examples, data collectors 106 with POS applications 110 are maintained within a corresponding store 104 at the point-of-sale (e.g., checkout counter). In some examples, data collectors 106 with POS applications 110 are integrated with a cash register such that data is collected automatically as products are scanned for purchases at the cash register. In other examples, the data collector 106 may be independent of the cash register.

In some examples, data collectors 106 with auditor applications 112 correspond to portable computing devices (e.g., smartphones, tablets, etc.) that may be carried by an auditor that may visit a store 104 to collect desired marketing and sales data (e.g., collection information) associated with particular products of interest. Additionally or alternatively, in some examples, the auditor applications may be implemented in a drone and/or robot capable of moving throughout a store 104 to collect the marketing and sales data. In some examples, the drone and/or robot is controlled by an auditor. In some examples, the drone and/or robot device is autonomously controlled. In some examples, a single auditor may visit multiple different stores 104 and collect relevant collection information from each store using the same data collector 106. As used herein, an auditor is a person specifically commissioned by the market research entity 108 to visit one or more particular stores 104, as directed by the market research entity 108, to gather collection information and report such information back to the market research entity 108.

In some examples, data collectors 106 with store owner applications 114 correspond to computing devices available to a store owner (or other employee working at the store 104) to gather and report collection information associated with particular products sold at the store 104 and report such information to the market research entity 108. In some examples, such data collectors 106 with store owner applications 114 correspond to portable computing devices (e.g., smartphones, tablets, etc.) that may be carried by personnel within the store 104 similar to the portable computing devices carried by auditors sent by the market research entity 108. Additionally or alternatively, in some examples, data collectors 106 with store owner applications 114 correspond to desktop computers that may be maintained at a fixed location within the store 104 (or at a remote location) with access to marketing and sales data associated with produces sold at the store 104. Additionally or alternatively, in some examples, the store owner application 114 is implemented in a drone and/or robot capable of moving throughout a store 104 (either autonomously or as controlled by a human).

In some examples, data collectors 106 with third-party vendor applications 116 correspond to any type of data collectors 106 that are managed and/or maintained by entities other than the owner and/or operator of the store 104 and other than the market research entity 108. For example, a particular product provider 102 may perform its own audit of a particular store 104 to gather a marketing and sales data with a corresponding data collector 106 with a third-party vendor application 116 and report the collected information to the market research entity 108.

In some examples, the market research entity 108 performs market research at the request of ones of the product provider(s) 102 and/or the store(s) 104. In some examples, the market research entity 108 corresponds to one of the product provider(s) 102 and/or the store(s) 104. In other examples, as represented in FIG. 1, the market research entity 108 is an independent third-party (e.g., The Nielsen Company (US), LLC).

In some examples, the data collectors 106 are capable of communicating with the market research entity 108 via a network (e.g., the Internet). In some such examples, the market research entity 108 may transmit instructions to the data collectors 106 identifying what store(s) 104 to visit (e.g., if the data collector 106 is associated with an auditor of the market research entity 108) and/or the particular products for which marketing and sales data is to be collected. In some examples, the data collectors 106 may include sensors to scan barcodes and/or capture pictures of the identified products of interests to facilitate the collection of data. Additionally or alternatively, in some examples, particular individuals (e.g., store managers and/or employees, auditors, etc.) may enter their observations directly onto the data collectors 106 (e.g., via a keyboard and/or touchscreen) as part of the data collection process. In some examples, the data collectors 106 are devices dedicated to the collection of marketing and sales data. In other examples, the data collectors 106 may be multi-function computing device (e.g., a smartphone, a tablet, etc.) that includes an application to facilitate the collection of data and the communication of such data to the market research entity 108.

Regardless of the particular way in which the data is collected or the type of data collector 106 through which the collecting is accomplished, once the data is collected, the data is transmitted to the market research entity 108. More particularly, in some examples, data from multiple data collectors 106 are transmitted to a data processing apparatus 118 of the market research entity 108 to aggregate and process the collected data. In some examples, the data processing apparatus 118 generates reports based on findings and/or insights obtained from an analysis of the collected data. In some examples, such reports may be provided to the product provider(s) 102 and/or the store(s) 104. In some instances, the insights gained from an analysis of collected data may reveal potentially inaccurate collection information. In some examples, inaccurate collection information is identified based on discrepancies between predicted values for the collected information and the actual values of the reported collection information. More particularly, collection information is designated as inaccurate when a disparity between the predicted values for the collection information and the actual values of the collection information satisfies (e.g., exceeds) a threshold. In some examples, the predicted values are generated by a machine learning model analyzing historical collection information for a corresponding store 104 (e.g., collection information collected during a period of time before the time associated with currently (e.g., most recently) reported collection information). Additionally or alternatively, in some examples, predicted values may be generated by a machine learning model analyzing the historical and/or currently reported collection information for other stores that are similar to a particular store 104 of interest.

Further, in some examples, predicted values for collection information may be generated based on an analysis of events potentially affecting the sale of products at the store 104 of interest. Events potentially affecting the sale of products may include any type of event or situations that can affect the sale of products such as, for example, marketing events (e.g., advertising campaigns, promotional sales, etc.), weather events (e.g., natural disasters, storms, non-typical temperatures, etc.), political/social events (e.g., protests, demonstrations, lockdowns, pandemics, etc.), seasonal events (e.g., holidays, beginning/ending of school, etc.), store-related events (e.g., store closures due to renovations or other factors) and so forth. Considering current events in assessing the accuracy of collection information is significant because particular events may prevent an auditor (e.g., human auditor(s), robotic auditor(s), drone auditor(s), etc.) from going to and/or otherwise being activated in the store to collect some or all of the desired collection information. For example, a flood at a near a particular store 104 may prevent an auditor from accessing the store 104 to perform a scheduled collection of marketing and sales data. In such situations, the missing information may result in the designation of inaccurate collection information because there will likely be a discrepancy between predicted values for the collection information and the actual values of the collection information because no collection information was collected or reported. In some examples, event information indicating particular events associated with particular products and/or particular stores 104 is reported via the data collector(s) 106. For instance, in connection with the above example, the auditor may use an auditor application 112 to report that collection information could not be obtained because there was a flood. As another example, an auditor may use an auditor application 112 to report event information indicating that a particular product is associated with a promotional event. Additionally or alternatively, in some examples, event information can be obtained from sources other than the data collectors 106. For instance, in some examples, the product providers 102 and/or the stores 104 may provide event information regarding marketing events, seasonal events, store-related events, and/or other types of events. Further, in some examples, event information may be obtained by monitoring news outlets reporting on areas associated with the relevant stores 104 to identify potential weather events, political/social events, and/or other types of events. In some examples, the data packets (stored in the data packet database 218) associated with particular products and particular stores is updated to include relevant event information corresponding to products and/or particular stores 104.

In some examples, when collection information is determined to be inaccurate (e.g., the discrepancy between predicted and actual values satisfies a threshold), the market research entity 108 may generate a work order or request for new collection information to be obtained. For example, the market research entity 108 may provide instructions to an auditor to return to a particular store 104 associated with the inaccurate collection information and re-collect the relevant information. Obtaining replacement collection information in this manner can be cost prohibitive. Furthermore, as noted above, particular events and/or circumstances may create situations where original collection information and/or replacement collection information is not available. Accordingly, in some examples, the market research entity 108 may generate simulated, synthetic, or synthesized data to replace inaccurate collection information in lieu of obtaining replacement collection information and/or to provide additional collection information when such information is otherwise unavailable for a particular period of interest. In some examples, the synthesized data is generated based on the application of a machine learning model to historical collection information for a particular store 104 of interest and/or for other similar stores 104.

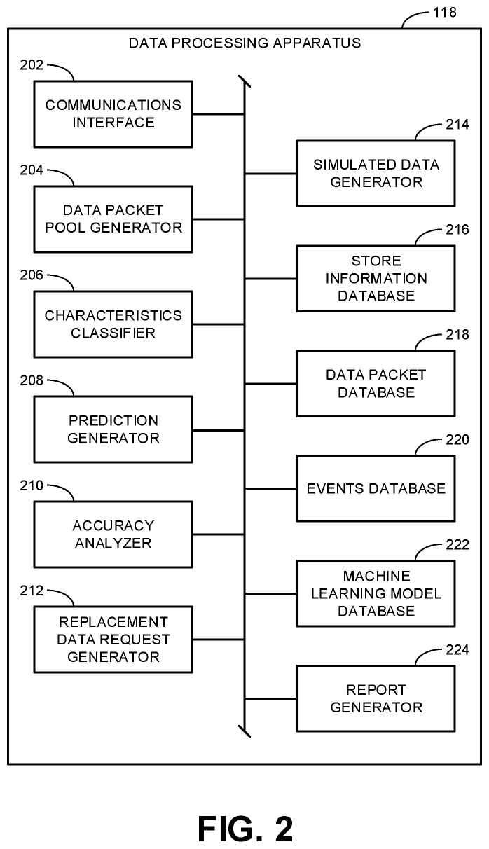

FIG. 2 is a block diagram of an example implementation of the example data processing apparatus 118 of FIG. 1. As shown in the illustrated example, the data processing apparatus 118 includes an example communications interface 202, an example data packet pool generator 204, an example characteristics classifier 206, an example prediction generator 208, an example accuracy analyzer 210, an example replacement data request generator 212, an example simulated data generator 214, an example store information database 216, an example data packet database 218, an example events database 220, an example machine learning model database 222, and an example report generator 224.

The example communications interface 202 of the illustrated example enables communications between the data processing apparatus 118 of the market research entity 108 and any of the product provider(s) 102, the store(s) 104, and/or the data collector(s) 106. More particularly, in some examples, the communications interface 202 receives collection information (e.g., sales units, sale volume, product pricing information, promotional details, etc.) reported from the data collectors 106. In some examples, the communications interface 202 transmits instructions to the data collectors 106 that define and/or request relevant information to be collected in connection with a particular research study. Further, in some examples, the communications interface 202 receives information from the stores 104 and/or the product providers 102 relevant to particular research studies. For instance, stores 104 may provide store information (e.g., store location, store size, store type, etc.) used in connection with the collection information reported by the data collectors 106. In some examples, the store information may be provided via the data collectors 106 along with the collection information. In some examples, the communications interface 202 transmits reports generated as a result of particular research studies back to the stores 104 and/or the product providers 102.

In some examples, the store information (whether received from the stores 104 directly or from the data collectors 106) is stored in the example store information database 216. In some examples, the collection information received from the data collectors 106 is stored in a separate database. However, in the illustrated example, the collection information is first processed by the example data packet pool generator 204 to combine the collection information with the store information to form data packets that are stored in the example data packet database 218. As used herein, a data packet is a collection of data that is specific to a particular store and specific to one or more particular product(s) of interest for which marketing and sales data is collected. Each data packet includes at least three types of data include (1) store information, (2) collection information, and (3) a channel identifier. As outlined above, store information includes data indicative of the characteristics of the particular store associated with the data packet and the collection information includes marketing and sales data for the particular product(s) associated with the data packet. The channel identifier is an identifier indicating the data collection channel through which the collection information was obtained. That is, the channel identifier indicates whether the collection information was provided via a POS application 110, an auditor application 112, a store owner application 114, or a third-party vendor application 116. As discussed in greater detail below, collection information may also be synthesized or simulated to create simulated data packets. Accordingly, the channel identifier for simulated data packets would indicate the data was simulated. In some examples, following analysis of the data packets, as described further below, the data packet further includes an accuracy indicator to indicate whether the collection information in the data packet is designated as accurate or inaccurate.

All data packets, whether based on actual collection information reported by a data collector 106 or synthetically generated, are stored in the example data packet database 218 and form a pool of data from which the data packets may be analyzed to identify potential inaccuracies and/or gaps in the marketing and sales data reflected by the data packets. As described further below, the identification of inaccuracies and/or incomplete data can be used to collect additional and/or replacement data and/or generate additional and/or replacement simulated data to enhance the quality and/or accuracy of the collected data.

The example characteristics classifier 206 classifies the data packets in the data packet database 218 based on characteristics of the stores 104 associated with the data packets and/or any other relevant information. That is, in some examples, the characteristics classifier 206 groups different ones of the data packets into different groupings based on the store information included in the data packets. In some examples, the characteristics classifier 206 enables data packets associated with stores 104 having some similarities to be grouped and analyzed together. In some examples, the stores 104 are grouped based on geographic location. That is, stores 104 in a particular region are identified for a particular grouping of the data packets. Additionally or alternatively, the data packets may be grouped based on one or more other characteristics (e.g., store size, store type, etc.). In some examples, the groupings or classification of data packets may be based on deterministic rules. Additionally or alternatively, the characteristics classifier 206 may analyze the data packets with a machine learning model stored in the machine learning model database 222 to identify patterns and/or similarities between different data packets and group such data packets accordingly.

The example prediction generator 208 analyzes the data packets within the data packet database 218 associated with historical collection information to predict values for the collection information of particular data packets for a particular (e.g., most recent) period of time for which new collection information is to be or has been provided by the data collectors 106. In some examples, the prediction generator 208 determines the predicted values for the collection information by implementing a machine learning model stored in the example machine learning model database 222. As noted above, in some examples, the inputs to the machine learning model include historical collection information. In some examples, the historical collection information corresponds to collection information associated with the same store 104 as associated with a particular data packet containing the current (e.g., most recent) collection information for the store 104. Additionally or alternatively, the historical collection information may include collection information associated with other stores 104 similar to the first store. Additionally or alternatively, the historical collection information may include simulated collection information that was generated to correct and/or replace historical collection information found to be inaccurate as discussed further below

In addition to historical collection information, in some examples, event information may be used as a separate input to the machine learning model implemented by the example prediction generator 208 to generate predicted values for collection information for particular data packets. In some examples, the event information is stored in the example events database 220. The event information may include an indication of any types of events potentially affecting the sale of products at the particular stores 104 of interest. Events potentially affecting the sale of products may include any type of event or situations that can affect the sale of products such as, for example, marketing events (e.g., advertising campaigns, promotional sales, etc.), weather events (e.g., natural disasters, storms, non-typical temperatures, etc.), political/social events (e.g., protests, demonstrations, lockdowns, pandemics, etc.), seasonal events (e.g., holidays, beginning/ending of school, etc.), and so forth. In some examples, a separate prediction may be made for each type of collection information included in the data packets. For example, a first value may be predicted for sales volume of a product during a particular (e.g., most recent) period of time and a second value may be predicted for the price of the product during the relevant period. The predicted values are generated to serve as a comparison to actual values of the collection information to identify irregularities and/or errors in the collected data.

In some examples, the prediction generator 208 implements a single machine learning model (e.g., such as a decision tree or a logistic regression) to arrive at a single predicted value (or a set of predicted values if there are multiple types of collection information being analyzed). In other examples, multiple different machine learning models may be implemented to generate different predictions. In some examples, the different predicted values may be combined through weighted aggregation. In some examples, the different predicted values may be ranked with particular ones of the predicted values selected for use in the subsequent analysis.

The example accuracy analyzer 210 determines an accuracy of the collection information included in the data packets by comparing the actual values of the collection information in the data packets to the predicted values for the collection information generated by the example prediction generator 208. When the comparison results in a discrepancy that satisfies (e.g., exceeds) a threshold, the accuracy analyzer 210 designates the collection data as inaccurate. If the threshold is not satisfied, the example accuracy analyzer 210 designates the collection data as accurate. In some examples, the data packets are updated to include an accuracy indicator that specifies the designation of the collection information determined by the example accuracy analyzer 210. The discrepancy between the predicted and actual values for the collection information may be calculated in any suitable way. For instance, in some examples, the discrepancy is calculated as the difference between the predicted values and the actual values. Additionally or alternatively, the discrepancy may be calculated as the square of the difference or the square root of the difference. In some examples, the discrepancy may result from the absence of actual collection information rather than an error in the collection information. For instance, in some examples, expected collection information may not be available and/or was not collected for some reason such that there is a gap in the data. In some such examples, the discrepancy may still be calculated by assigning the actual values for the collection information to zero and treating the results as outlined below.

In some examples, a different discrepancy is calculated for each type of collection information. For example, a first discrepancy between the predicted sales volume of a product and the actual sales volume of the product may be calculated with a second discrepancy between the predicted price for the product and the actual price for the product separately calculated. In some examples, when multiple discrepancies are calculated for different items of collection information, the accuracy analyzer 210 designates the data packet as inaccurate when at least one of the discrepancies (associated with a particular item and/or type of collection information) satisfies (e.g., exceeds) a threshold. In some examples, different thresholds may be applied to the different types of collection information. In some examples, different discrepancies are combined into a single discrepancy and/or a composite discrepancy that accounts for multiple types of collection information. Such combined or composite discrepancies may be calculated and compared to a corresponding threshold to determine whether the data packet (containing all the corresponding collection information) is accurate or inaccurate.

The example replacement data request generator 212 analyzes data packets designated as inaccurate by the example accuracy analyzer 210 to determine whether new or replacement collection information should be obtained to replace the inaccurate collection information. In some examples, the replacement data request generator 212 determines whether to obtain replacement collection information by implementing a machine learning model stored in the example machine learning model database 222. In some examples, the machine learning model is developed to strike a balance between improved accuracy of the collection information and the costs associated with achieving such improvements.

Costs may be affected by the type of data collection channel used to obtain both the initial collection information and any replacement collection information. For instance, sending an auditor into a particular store 104 with a data collector 106 having an auditor application 112 involves more time and expense to the market research entity 108 than requesting collection information from a data collector 106 located at the store 104 with a POS application 110. However, an auditor may be able to provide more accurate and/or complete information than what is available through the POS application 110. Thus, a balance must be struck between the different data collection channels and the associated costs. Accordingly, in some examples, the machine learning model used to determine whether to obtain replacement collection data considers all data packets within a particular grouping of data packets classified by the example characteristics classifier 206 in the context of limits and/or thresholds on the costs to be incurred for collecting data. Further, in some examples, the machine learning model is implemented in the context of limits and/or thresholds on the number of different data packets for which replacement data may be requested from each available data collection channel. Further, in some examples, the replacement data request generator 212 may determine (via the machine learning model) whether to request replacement collection information from the same store 104 from which the original (inaccurate) collection information was obtained or whether to request the replacement collection information from a different store 104 that is similar and/or otherwise associated with the data packet having data to be replaced (e.g., the different store 104 contains characteristics that would result in the same classification by the characteristics classifier 206). In some examples, the replacement data request generator 212 uses event information (stored in the events database 220) as an input to the machine learning model to facilitate determination of whether to seek new or replacement collection information and from where such replacement collection information data should be obtained. For instance, if event information indicates a particular store is closed or otherwise inaccessible (e.g., due to store renovations), it would not make sense to send an auditor back to that store. Rather, in some such examples, the replacement data request generator 212 can determine to send the auditor to a different store.

In some examples, out of cost considerations, relevant events, and/or other factors, the replacement data request generator 212 may determine not to obtain replacement collection data for one or more data packets designated by the accuracy analyzer 210 as inaccurate. In some examples, the simulated data generator 214 may analyze such data packets to determine whether to generate or synthesize simulated collection information to replace the inaccurate collection information originally reported by one or more data collectors 106. In this manner, the accuracy of the data may be enhanced without incurring the significant costs attendant with seeking and obtaining replacement collection information.

In some examples, when the simulated data generator 214 determines to generate simulated collection information, the simulated data generator 214 generates the simulated data using a machine learning model that uses historical collection information. As with the example prediction generator 208, the historical collection information may include collection information associated with a particular store 104 of interest, collection information associated with other similar stores 104, and/or previously generated simulated information. Further, in some examples, the event information contained in the events database 220 may also serve as an input to the machine learning model implemented by the simulated data generator 214 to generate new simulated collection information.

In some examples, simulated and/or replacement collection information may be provided to the data packet database 218 as new and/or additional data packets that may be analyzed as described above. In some examples, the process of detecting inaccurate data packets and generating and/or correcting such data packets may be iterated through multiple times before final data is arrived at for a given period. In some examples, the number of iterations through the process can play a role in the determination of whether to request the procurement of replacement collection information and/or to generate simulated collection information. For instance, in a first iteration of the process, the example replacement data request generator 212 may determine to request replacement collection information to be obtained. However, if an analysis of the newly collected data packets in a subsequent iteration of the process reveals persistent inaccuracies, the example replacement data request generator 212 may determine not to obtain additional replacement collection information (e.g., for a third or additional time) but instead cause the example simulated data generator 214 to generate simulated data. In some examples, this final data (e.g., after all iterations through the process) is provided to the example report generator 224 to generate a report. The report may be provided (e.g., transmitted via the communications interface 202) to the product provider(s) 102 and/or the stores(s) 104 to use as appropriate (e.g., adjust marketing campaigns, restock inventory, etc.).

In some examples, marketing data (e.g., collection information, store information, and/or event information) is collected from numerous data collectors 106 and/or other sources reporting data associated with numerous stores 104. This can result in large amounts of data that need to be processed and/or analyzed relatively quickly to provide reliable and up to date results of the current situation of particular markets of interest to the product provider(s) 102 and/or the stores 104. The need to process large amounts of data in relatively short time periods so that either replacement collection information can be obtained or simulated data can be generated to produce accurate and timely marketing statistics are some of the technological challenges in the technical field of market research that rely on network communications between many different devices to enable the efficient and accurate collection of the data and also rely on efficient computer processors to analyze the data to generate reliable and accurate statistics in a constantly changing marketplace. The nature and amount of the data collected and the speed at which such data is collected and processed cannot reasonably be completed manually by humans but requires technological solutions.

While an example manner of implementing the data processing apparatus 118 of FIG. 1 is illustrated in FIG. 2, one or more of the elements, processes and/or devices illustrated in FIG. 2 may be combined, divided, re-arranged, omitted, eliminated and/or implemented in any other way. Further, the example communications interface 202, the example data packet pool generator 204, the example characteristics classifier 206, the example prediction generator 208, the example accuracy analyzer 210, the example replacement data request generator 212, the example simulated data generator 214, the example store information database 216, the example data packet database 218, the example events database 220, the example machine learning model database 222, the example report generator 224, and/or, more generally, the example data processing apparatus 118 of FIG. 1 may be implemented by hardware, software, firmware and/or any combination of hardware, software and/or firmware. Thus, for example, any of the example communications interface 202, the example data packet pool generator 204, the example characteristics classifier 206, the example prediction generator 208, the example accuracy analyzer 210, the example replacement data request generator 212, the example simulated data generator 214, the example store information database 216, the example data packet database 218, the example events database 220, the example machine learning model database 222, the example report generator 224 and/or, more generally, the example data processing apparatus 118 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example communications interface 202, the example data packet pool generator 204, the example characteristics classifier 206, the example prediction generator 208, the example accuracy analyzer 210, the example replacement data request generator 212, the example simulated data generator 214, the example store information database 216, the example data packet database 218, the example events database 220, the example machine learning model database 222, and/or the example report generator 224 is/are hereby expressly defined to include a non-transitory computer readable storage device or storage disk such as a memory, a digital versatile disk (DVD), a compact disk (CD), a Blu-ray disk, etc. including the software and/or firmware. Further still, the example data processing apparatus 118 of FIG. 1 may include one or more elements, processes and/or devices in addition to, or instead of, those illustrated in FIG. 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

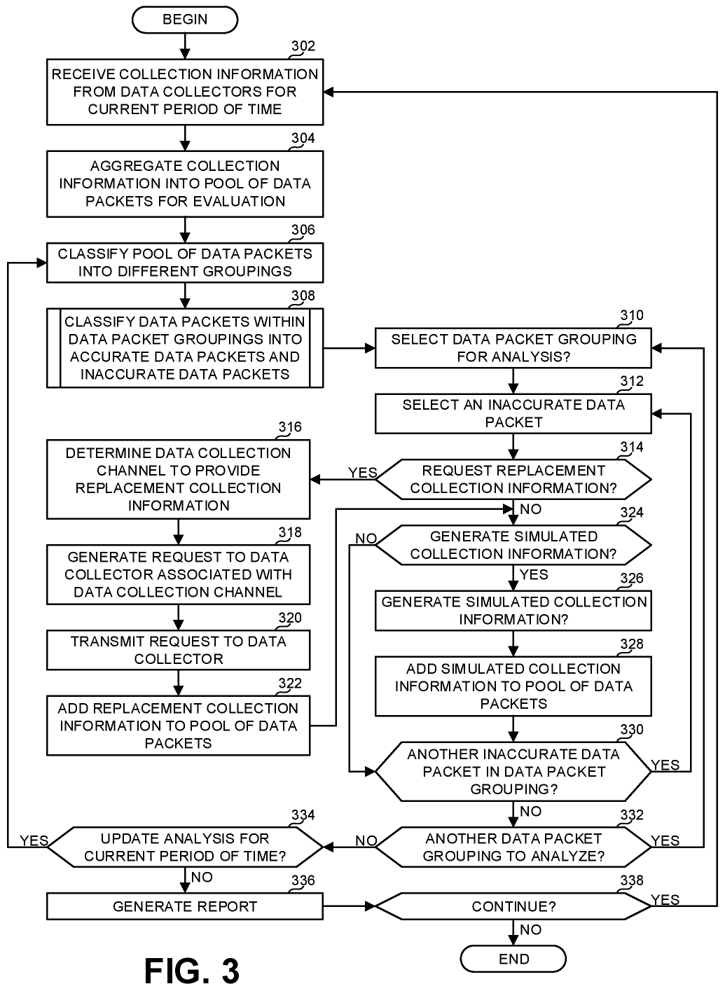

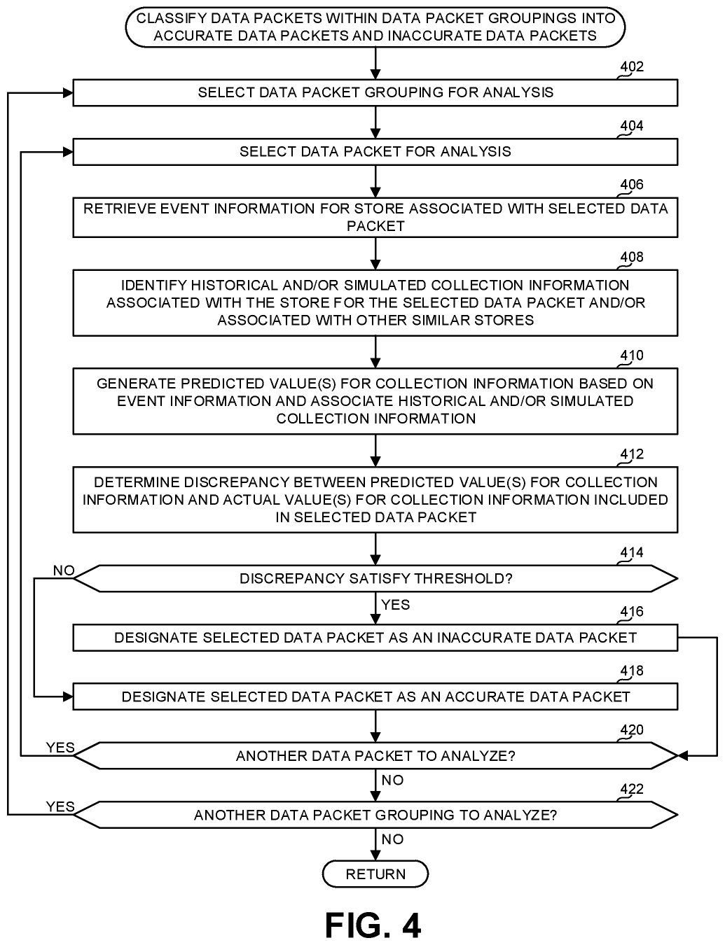

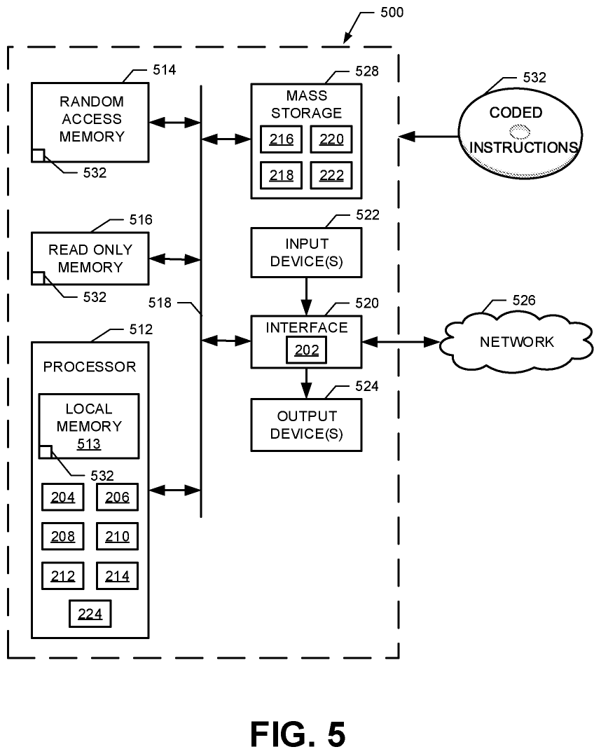

A flowchart representative of example hardware logic, machine readable instructions, hardware implemented state machines, and/or any combination thereof for implementing the data processing apparatus 118 of FIGS. 1 and/or 2 is shown in FIGS. 3 and 4. The machine readable instructions may be one or more executable programs or portion(s) of an executable program for execution by a computer processor and/or processor circuitry, such as the processor 512 shown in the example processor platform 500 discussed below in connection with FIG. 5. The program may be embodied in software stored on a non-transitory computer readable storage medium such as a CD-ROM, a floppy disk, a hard drive, a DVD, a Blu-ray disk, or a memory associated with the processor 512, but the entire program and/or parts thereof could alternatively be executed by a device other than the processor 512 and/or embodied in firmware or dedicated hardware. Further, although the example program is described with reference to the flowchart illustrated in FIGS. 3 and 4, many other methods of implementing the example data processing apparatus 118 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 3 and 4 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

The program of FIG. 3 begins at block 302 where the example communications interface 202 receives collection information from data collectors 106 for a current (e.g., most recent) period of time. At block 304, the example data packet pool generator 204 aggregates the collection information into a pool of data packets for evaluation. At block 306, the example characteristics classifier 206 classifies the pool of data packets into different groupings. At block 308, the data processing apparatus classifies the data packets within the different data packet groupings into accurate data packets and inaccurate data packets. Further detail regarding the implementation of block 308 is provided below in connection with FIG. 4.

At block 310, the example replacement data request generator 212 selects a data packet grouping for analysis. In some examples, multiple different data packet groupings may be analyzed at the same time (e.g., in parallel). At block 312, the example replacement data request generator 212 selects an inaccurate data packet (e.g., from within the data packet grouping selected at block 310). In some examples, multiple different inaccurate data packets may be selected for analysis at the same time (e.g., in parallel). At block 314, the example replacement data request generator 212 determines whether to request replacement collection information. In some examples, this determination is at least partially based on event information associated with the particular product and/or store 104 corresponding to the data packet under analysis. If replacement collection information is to be requested, control advances to block 316 where the example replacement data request generator 212 determines the data collection channel to provide the replacement collection information. In some examples, the particular data collection channel to provide the replacement collection information is based at least partially on the event information associated with the data packet. At block 318, the example replacement data request generator 212 generates a request to the data collector 106 associated with the data collection channel identified at block 316. In some examples, the request includes an indication of the collection information that is to be collected. Further, in some examples, the request may identify the particular store 104 from which the collection information is to be collected, which may be the same store 104 where the original (inaccurate) collection information was obtained or a different, similar store 104. At block 320, the example communications interface 202 transmits the request to the data collector. Once the new, replacement collection information is received, the example data packet pool generator 204 adds the replacement collection information to the pool of data packets (block 322). Thereafter, control advances to block 324.

Returning to block 314, if the example replacement data request generator 212 determines not to request replacement collection information, control advances directly to block 324. At block 324, the example simulated data generator 214 determines whether to generate simulated collection information. If so, control advances to block 326 where the example simulated data generator 214 generates the simulated collection information. At block 328, the example data packet pool generator 204 adds the simulated collection information to the pool of data packets. Thereafter, control advances to block 330. If, at block 324, the example simulated data generator 214 determines not to generate simulated collection information, control advances directly to block 330.

At block 330, the example replacement data request generator 212 determines whether there is another inaccurate data packet in the selected data packet grouping. If so, control returns to block 312. Otherwise, control advances to block 332 where the example replacement data request generator 212 determines whether there is another data packet grouping to analyze. If so, control returns to block 310. Otherwise, control advances to block 334.

At block 334, the example data processing apparatus 118 determines whether to update the analysis for the current period of time. That is, the apparatus 118 determines whether to iterate through the process based on any updated data that may have been received (e.g., replacement collection information) and/or generated (e.g., simulated collection information). If so, control returns to block 306. Otherwise, control advances to block 336 where the example report generator generates a report. Thereafter, at block 338, the example data processing apparatus 118 determines whether to continue. If so, control returns to block 302. Otherwise, the example process of FIG. 3 ends.

As mentioned above, FIG. 4 is a flowchart illustrating an example process to implement block 308 of FIG. 3. The example process of FIG. 4 begins at block 402 where the example prediction generator 208 selects a data packet grouping for analysis. In some examples, multiple different data packet groupings may be analyzed at the same time (e.g., in parallel). At block 404, the example prediction generator 208 selects a data packet (within the particular data packet grouping selected at block 402) for analysis. In some examples, multiple different data packets may be analyzed at the same time (e.g., in parallel). At block 406, the example prediction generator 208 retrieves event information for the store 104 associated with the selected data packet (e.g., form the events database 220). At block 408, the example prediction generator 208 identifies historical and/or simulated collection information associated with the store 104 for the selected data packet and/or associated with other similar stores 104. At block 410, the example prediction generator 208 generates predicted value(s) for collection information based on the event information and the historical and/or simulated collection information.

At block 412, the example accuracy analyzer 210 determines a discrepancy between the predicted value(s) for the collection information and the actual value(s) for the collection information included in the selected data packet. At block 414, the example accuracy analyzer 210 determines whether the discrepancy satisfies a threshold. If so, control advances to block 416 where the example accuracy analyzer 210 designates the selected packet as an inaccurate data packet. Thereafter, control advances to block 420. Returning to block 414, if the example accuracy analyzer 210 determines that the discrepancy does not satisfy the threshold, control advances to block 418 where the example accuracy analyzer 210 designates the selected packet as an accurate data packet. In some examples, the designation of accurate or inaccurate is indicated by an accuracy indicator included in the correspond data packet. In other examples, the designation is made by assigning the data packet to either an accurate data packet database or an inaccurate data packet database.

Once the data packet has been designated as either accurate or inaccurate, control advances to block 420 where the example prediction generator 208 determines whether there is another data packet to analyze (within the data packet grouping selected at block 402). If so, control returns to block 404. Otherwise, control advances to block 422 where the example prediction generator 208 determines whether there is another data packet grouping to analyze. If so, control returns to block 402. Otherwise, the example process of FIG. 4 ends and returns to complete the process of FIG. 3.

FIG. 5 is a block diagram of an example processor platform 500 structured to execute the instructions of FIGS. 3 and 4 to implement the data processing apparatus 118 of FIGS. 1 and/or 2. The processor platform 500 can be, for example, a server, a personal computer, a workstation, a self-learning machine (e.g., a neural network), a mobile device (e.g., a cell phone, a smart phone, a tablet such as an iPad), a personal digital assistant (PDA), an Internet appliance, or any other type of computing device.

The processor platform 500 of the illustrated example includes a processor 512. The processor 512 of the illustrated example is hardware. For example, the processor 512 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example characteristics classifier 206, the example prediction generator 208, the example accuracy analyzer 210, the example replacement data request generator 212, the example simulated data generator 214, the example store information database 216, the example data packet database 218, the example events database 220, the example machine learning model database 222, and the example report generator 224.

The processor 512 of the illustrated example includes a local memory 513 (e.g., a cache). The processor 512 of the illustrated example is in communication with a main memory including a volatile memory 514 and a non-volatile memory 516 via a bus 518. The volatile memory 514 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 516 may be implemented by flash memory and/or any other desired type of memory device. Access to the main memory 514, 516 is controlled by a memory controller.

The processor platform 500 of the illustrated example also includes an interface circuit 520. The interface circuit 520 may be implemented by any type of interface standard, such as an Ethernet interface, a universal serial bus (USB), a Bluetooth® interface, a near field communication (NFC) interface, and/or a PCI express interface.

In the illustrated example, one or more input devices 522 are connected to the interface circuit 520. The input device(s) 522 permit(s) a user to enter data and/or commands into the processor 512. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 524 are also connected to the interface circuit 520 of the illustrated example. The output devices 524 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 520 of the illustrated example, thus, typically includes a graphics driver card, a graphics driver chip and/or a graphics driver processor.

The interface circuit 520 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 526. The communication can be via, for example, an Ethernet connection, a digital subscriber line (DSL) connection, a telephone line connection, a coaxial cable system, a satellite system, a line-of-site wireless system, a cellular telephone system, etc.

The processor platform 500 of the illustrated example also includes one or more mass storage devices 528 for storing software and/or data. Examples of such mass storage devices 528 include floppy disk drives, hard drive disks, compact disk drives, Blu-ray disk drives, redundant array of independent disks (RAID) systems, and digital versatile disk (DVD) drives.

The machine executable instructions 532 of FIGS. 3 and 4 may be stored in the mass storage device 528, in the volatile memory 514, in the non-volatile memory 516, and/or on a removable non-transitory computer readable storage medium such as a CD or DVD.

From the foregoing, it will be appreciated that example methods, apparatus and articles of manufacture have been disclosed that enable the identification of potentially inaccurate collection information based on machine learning models and the automatic correction and/or enhancement of such data by generating requests for replacement collection information and/or by generating simulated collection information in a cost effective manner. In some examples, the determination of whether to procure replacement collection information and/or generate simulated information is based on event information associated with the particular products regarding which information is collected and/or associated with the stores where the collection information was obtained. Making cost assessments between different alternative avenues for acquiring replacement collection information and/or generating simulated information while also accounting for unique circumstances of individuals stores based on event information cannot reasonably be accomplished by a human in the mind or with the aid of pen and paper. That this process is a technologically rigorous process that cannot reasonably be performed manually by a human, is made all the more apparent when it is recognized that events can change at any given time and on an ongoing basis and decisions about replacing collected information or generating simulated information need to be made for large numbers of different stores and/or products on a regular basis. Examples disclosed herein improve this technologically rigorous process by implementing machine learning models that can determine when and/or how to obtain replacement collection information and when to generate simulated data so that the final results are both reliable and arrived at in an efficient manner.

Example 1 includes an apparatus comprising at least one memory instructions, and at least one processor to execute the instructions to aggregate marketing and sales data into a pool of data packets associated with different stores, the data packets including information associated with sales of a particular product sold at corresponding ones of the different stores, classify different ones of the data packets into either an accurate data packet set or an inaccurate data packet set, determine whether to request replacement information for a first data packet in the inaccurate data packet set, and in response to a determination to request the replacement information, cause transmission of a request to a data collector to provide the replacement information.

Example 2 includes the apparatus of example 1, wherein the at least one processor is to, in response to a determination not to request replacement information for the first data packet, generate simulated information for the first data packet based on the information for ones of the data packets in the accurate data packet set.

Example 3 includes the apparatus of example 1, wherein the information is collection information, the data packets further include store information indicative of characteristics of corresponding ones of the different stores, and the at least one processor is to classify the pool of data packets into different data packet groupings based on the store information, each of the different ones of the data packets in the accurate data packet set and each of the different ones of the data packets in the inaccurate data packet set associated with a same first data packet grouping, and determine an accuracy of the collection information for ones of the data packets within corresponding ones of the data packet groupings.

Example 4 includes the apparatus of example 1, wherein the information in the data packets corresponds to actual collection information, and the at least one processor is to generate predicted collection information, determine a discrepancy between the predicted collection information and the actual collection information, and determine an accuracy of the actual collection information based on the discrepancy, the classifying of the different ones of the data packets into either the accurate data packet set or the inaccurate data packet set based on the accuracy of the actual collection information.

Example 5 includes the apparatus of example 4, wherein the actual collection information includes simulated collection information.

Example 6 includes the apparatus of example 4, wherein the accuracy of the actual collection information is based on event information associated with at least one of the particular product or the corresponding store associated with the first data packet.

Example 7 includes the apparatus of example 1, wherein the data packets include a channel identifier to indicate a data collection channel through which the information in corresponding ones of the data packets was obtained.

Example 8 includes the apparatus of example 1, wherein the at least one processor is to determine whether to request replacement information based on a first limit on a cost for collecting data and on a second limit on a number of different data packets for which replacement information is to be requested.

Example 9 includes the apparatus of example 8, wherein the at least one of the first limit or the second limit is autonomously adjusted over time using a machine learning model.

Example 10 includes the apparatus of example 1, wherein the at least one processor is to determine whether to request replacement information based on event information associated with at least one of a product or a store associated with the first data packet.

Example 11 includes the apparatus of example 1, wherein the at least one processor is to execute a machine learning model to determine whether to request replacement information.

Example 12 includes an apparatus comprising a data packet pool generator to aggregate marketing and sales data into a pool of data packets associated with different stores, the data packets including information associated with sales of a particular product sold at corresponding ones of the different stores, a characteristics classifier to classify different ones of the data packets into either an accurate data packet set or an inaccurate data packet set, replacement data request generator to determine whether to request replacement information for a first data packet in the inaccurate data packet set, and a communications interface to, in response to a determination to request the replacement information, transmit a request to a data collector to provide the replacement information.

Example 13 includes the apparatus of example 12, further including a simulated data generator to, in response to a determination not to request replacement information for the first data packet, generate simulated information for the first data packet based on the information for ones of the data packets in the accurate data packet set.

Example 14 includes the apparatus of example 12, wherein the information is collection information, the data packets further include store information indicative of characteristics of corresponding ones of the different stores, and the characteristics classifier is to classify the pool of data packets into different data packet groupings based on the store information, each of the different ones of the data packets in the accurate data packet set and each of the different ones of the data packets in the inaccurate data packet set associated with a same first data packet grouping, the apparatus further including an accuracy analyzer to determine an accuracy of the collection information for ones of the data packets within corresponding ones of the data packet groupings.

Example 15 includes the apparatus of example 12, wherein the information in the data packets corresponds to actual collection information, the apparatus further including a prediction generator to generate predicted collection information, and an accuracy analyzer to determine a discrepancy between the predicted collection information and the actual collection information, and determine an accuracy of the actual collection information based on the discrepancy, the characteristics classifier to classify the different ones of the data packets into either the accurate data packet set or the inaccurate data packet set based on the accuracy of the actual collection information.

Example 16 includes the apparatus of example 15, wherein the actual collection information includes simulated collection information.

Example 17 includes the apparatus of example 15, wherein the accuracy of the actual collection information is based on event information associated with at least one of the particular product or the corresponding store associated with the first data packet.

Example 18 includes the apparatus of example 12, wherein the data packets include a channel identifier to indicate a data collection channel through which the information in corresponding ones of the data packets was obtained.

Example 19 includes the apparatus of example 12, wherein the replacement data request generator is to determine whether to request replacement information based on a first limit on a cost for collecting data and on a second limit on a number of different data packets for which replacement information is to be requested.

Example 20 includes the apparatus of example 19, wherein the at least one of the first limit or the second limit is autonomously adjusted over time using a machine learning model.

Example 21 includes the apparatus of example 12, wherein the replacement data request generator is to determine whether to request replacement information based on event information associated with at least one of a product or a store associated with the first data packet.

Example 22 includes the apparatus of example 12, wherein the replacement data request generator is to execute a machine learning model to determine whether to request replacement information.

Example 23 includes At least one non-transitory computer readable medium comprising instructions that, when executed, cause at least one processor to at least aggregate marketing and sales data into a pool of data packets associated with different stores, the data packets including information associated with sales of a particular product sold at corresponding ones of the different stores, classify different ones of the data packets into either an accurate data packet set or an inaccurate data packet set, determine whether to request replacement information for a first data packet in the inaccurate data packet set, and in response to a determination to request the replacement information, cause transmission of a request to a data collector to provide the replacement information.

Example 24 includes the at least one non-transitory computer readable medium of example 23, wherein the instructions cause the at least one processor to, in response to a determination not to request replacement information for the first data packet, generate simulated information for the first data packet based on the information for ones of the data packets in the accurate data packet set.

Example 25 includes the at least one non-transitory computer readable medium of example 23, wherein the information is collection information, the data packets further include store information indicative of characteristics of corresponding ones of the different stores, and the instructions cause the at least one processor to classify the pool of data packets into different data packet groupings based on the store information, each of the different ones of the data packets in the accurate data packet set and each of the different ones of the data packets in the inaccurate data packet set associated with a same first data packet grouping, and determine an accuracy of the collection information for ones of the data packets within corresponding ones of the data packet groupings.

Example 26 includes the at least one non-transitory computer readable medium of example 23, wherein the information in the data packets corresponds to actual collection information, and the instructions cause the at least one processor to generate predicted collection information, determine a discrepancy between the predicted collection information and the actual collection information, and determine an accuracy of the actual collection information based on the discrepancy, the classifying of the different ones of the data packets into either the accurate data packet set or the inaccurate data packet set based on the accuracy of the actual collection information.

Example 27 includes the at least one non-transitory computer readable medium of example 26, wherein the actual collection information includes simulated collection information.

Example 28 includes the at least one non-transitory computer readable medium of example 26, wherein the accuracy of the actual collection information is based on event information associated with at least one of the particular product or the corresponding store associated with the first data packet.

Example 29 includes the at least one non-transitory computer readable medium of example 23, wherein the data packets include a channel identifier to indicate a data collection channel through which the information in corresponding ones of the data packets was obtained.

Example 30 includes the at least one non-transitory computer readable medium of example 23, wherein the instructions cause the at least one processor to determine whether to request replacement information based on a first limit on a cost for collecting data and on a second limit on a number of different data packets for which replacement information is to be requested.

Example 31 includes the at least one non-transitory computer readable medium of example 30, wherein the at least one of the first limit or the second limit is autonomously adjusted over time using a machine learning model.

Example 32 includes the at least one non-transitory computer readable medium of example 23, wherein the instructions cause the at least one processor to determine whether to request replacement information based on event information associated with at least one of a product or a store associated with the first data packet.

Example 33 includes the at least one non-transitory computer readable medium of example 23, wherein the instructions cause the at least one processor to execute a machine learning model to determine whether to request replacement information.

Example 34 includes a method comprising aggregating marketing and sales data into a pool of data packets associated with different stores, the data packets including information associated with sales of a particular product sold at corresponding ones of the different stores, classifying different ones of the data packets into either an accurate data packet set or an inaccurate data packet set, determining whether to request replacement information for a first data packet in the inaccurate data packet set, and in response to a determination to request replacement information, transmitting a request to a data collector to provide the replacement information.

Example 35 includes the method of example 34, further including, in response to a determination not to request replacement information for the first data packet, generating simulated information for the first data packet based on the information for ones of the data packets in the accurate data packet set.

Example 36 includes the method of example 34, wherein the information is collection information, the data packets further include store information indicative of characteristics of corresponding ones of the different stores, the method further including classifying the pool of data packets into different data packet groupings based on the store information, each of the different ones of the data packets in the accurate data packet set and each of the different ones of the data packets in the inaccurate data packet set associated with a same first data packet grouping, and determining an accuracy of the collection information for ones of the data packets within corresponding ones of the data packet groupings.

Example 37 includes the method of example 34, wherein the information in the data packets corresponds to actual collection information, the method further including generating predicted collection information, determining a discrepancy between the predicted collection information and the actual collection information, and determining an accuracy of the actual collection information based on the discrepancy, the classifying of the different ones of the data packets into either the accurate data packet set or the inaccurate data packet set based on the accuracy of the actual collection information.

Example 38 includes the method of example 37, wherein the actual collection information includes simulated collection information.

Example 39 includes the method of example 37, wherein the accuracy of the actual collection information is based on event information associated with at least one of the particular product or the corresponding store associated with the first data packet.

Example 40 includes the method of example 34, wherein the data packets include a channel identifier to indicate a data collection channel through which the information in corresponding ones of the data packets was obtained.

Example 41 includes the method of example 34, wherein the determining of whether to request replacement information is based on a first limit on a cost for collecting data and on a second limit on a number of different data packets for which replacement information is to be requested.

Example 42 includes the method of example 41, wherein the at least one of the first limit or the second limit is autonomously adjusted over time using a machine learning model.

Example 43 includes the method of example 34, wherein the determining of whether to request replacement information is based on event information associated with at least one of a product or a store associated with the first data packet.

Example 44 includes the method of example 34, further including executing a machine learning model to determine whether to request replacement information.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

1. An apparatus comprising:
at least one memory:
instructions; and
at least one processor to execute the instructions to:
aggregate marketing and sales data into a pool of data packets associated with different stores, the data packets including information associated with sales of a particular product sold at corresponding ones of the different stores;
classify different ones of the data packets into either an accurate data packet set or an inaccurate data packet set;
determine whether to request replacement information for a first data packet in the inaccurate data packet set; and
in response to a determination to request the replacement information, cause transmission of a request to a data collector to provide the replacement information.

2. The apparatus of claim 1, wherein the at least one processor is to, in response to a determination not to request replacement information for the first data packet, generate simulated information for the first data packet based on the information for ones of the data packets in the accurate data packet set.

3. The apparatus of claim 1, wherein the information is collection information, the data packets further include store information indicative of characteristics of corresponding ones of the different stores, and the at least one processor is to:
classify the pool of data packets into different data packet groupings based on the store information, each of the different ones of the data packets in the accurate data packet set and each of the different ones of the data packets in the inaccurate data packet set associated with a same first data packet grouping; and
determine an accuracy of the collection information for ones of the data packets within corresponding ones of the data packet groupings.

4. The apparatus of claim 1, wherein the information in the data packets corresponds to actual collection information, and the at least one processor is to:
generate predicted collection information;
determine a discrepancy between the predicted collection information and the actual collection information; and
determine an accuracy of the actual collection information based on the discrepancy, the classifying of the different ones of the data packets into either the accurate data packet set or the inaccurate data packet set based on the accuracy of the actual collection information.

5. The apparatus of claim 4, wherein the actual collection information includes simulated collection information.

6. The apparatus of claim 4, wherein the accuracy of the actual collection information is based on event information associated with at least one of the particular product or the corresponding store associated with the first data packet.

7. The apparatus of claim 1, wherein the data packets include a channel identifier to indicate a data collection channel through which the information in corresponding ones of the data packets was obtained.

8. The apparatus of claim 1, wherein the at least one processor is to determine whether to request replacement information based on a first limit on a cost for collecting data and on a second limit on a number of different data packets for which replacement information is to be requested.

9. The apparatus of claim 8, wherein the at least one of the first limit or the second limit is autonomously adjusted over time using a machine learning model.

10. The apparatus of claim 1, wherein the at least one processor is to determine whether to request replacement information based on event information associated with at least one of a product or a store associated with the first data packet.

11. The apparatus of claim 1, wherein the at least one processor is to execute a machine learning model to determine whether to request replacement information.

12. An apparatus comprising:
a data packet pool generator to aggregate marketing and sales data into a pool of data packets associated with different stores, the data packets including information associated with sales of a particular product sold at corresponding ones of the different stores;
a characteristics classifier to classify different ones of the data packets into either an accurate data packet set or an inaccurate data packet set;
replacement data request generator to determine whether to request replacement information for a first data packet in the inaccurate data packet set; and
a communications interface to, in response to a determination to request the replacement information, transmit a request to a data collector to provide the replacement information.

13. The apparatus of claim 12, further including a simulated data generator to, in response to a determination not to request replacement information for the first data packet, generate simulated information for the first data packet based on the information for ones of the data packets in the accurate data packet set.

14. The apparatus of claim 12, wherein the information is collection information, the data packets further include store information indicative of characteristics of corresponding ones of the different stores, and the characteristics classifier is to classify the pool of data packets into different data packet groupings based on the store information, each of the different ones of the data packets in the accurate data packet set and each of the different ones of the data packets in the inaccurate data packet set associated with a same first data packet grouping, the apparatus further including an accuracy analyzer to determine an accuracy of the collection information for ones of the data packets within corresponding ones of the data packet groupings.

15. The apparatus of claim 12, wherein the information in the data packets corresponds to actual collection information, the apparatus further including:
a prediction generator to generate predicted collection information; and
an accuracy analyzer to:
determine a discrepancy between the predicted collection information and the actual collection information; and
determine an accuracy of the actual collection information based on the discrepancy, the characteristics classifier to classify the different ones of the data packets into either the accurate data packet set or the inaccurate data packet set based on the accuracy of the actual collection information.

16-20. (canceled)

21. The apparatus of claim 12, wherein the replacement data request generator is to determine whether to request replacement information based on event information associated with at least one of a product or a store associated with the first data packet.

22. The apparatus of claim 12, wherein the replacement data request generator is to execute a machine learning model to determine whether to request replacement information.

23. At least one non-transitory computer readable medium comprising instructions that, when executed, cause at least one processor to at least:
aggregate marketing and sales data into a pool of data packets associated with different stores, the data packets including information associated with sales of a particular product sold at corresponding ones of the different stores;
classify different ones of the data packets into either an accurate data packet set or an inaccurate data packet set;
determine whether to request replacement information for a first data packet in the inaccurate data packet set; and
in response to a determination to request the replacement information, cause transmission of a request to a data collector to provide the replacement information.

24. The at least one non-transitory computer readable medium of claim 23, wherein the instructions cause the at least one processor to, in response to a determination not to request replacement information for the first data packet, generate simulated information for the first data packet based on the information for ones of the data packets in the accurate data packet set.

25. (canceled)

26. The at least one non-transitory computer readable medium of claim 23, wherein the information in the data packets corresponds to actual collection information, and the instructions cause the at least one processor to:
generate predicted collection information;
determine a discrepancy between the predicted collection information and the actual collection information; and
determine an accuracy of the actual collection information based on the discrepancy, the classifying of the different ones of the data packets into either the accurate data packet set or the inaccurate data packet set based on the accuracy of the actual collection information.

27-44. (canceled)
